(19) United States
(12) Patent Application Publication
(10) Pub. No.: US 2012/0207806 A1
(43) Pub. Date: Aug. 16, 2012

(54) Multi-purpose dental appliance cleaner

(76) Inventor: Patricia M. LoPesio, Medina, MN (US)

(21) Appl. No.: 12/931,936

(22) Filed: Feb. 15, 2011

(51) Int. Cl. A01N 65/36; A01P 3/00; A01P 1/00; A01N 65/08; A01N 25/08

(52) U.S. Cl. 424/409; 424/736; 424/766

(57) ABSTRACT

A safe and effective antimicrobial composition for conveniently cleaning dental appliances like athletic mouth guards, night guards, orthodontic retainers and Invisalign-style braces, and teeth whitening trays of harmful germs, bacteria, molds, odors, and stains. Such composition comprises a plant-based anti-microbial extract like grapefruit seed extract in combination with a cleaning agent without the need for additional ascorbic acid or metal cation-based antibacterial agents. The cleaning composition can be delivered to the dental appliance as a rinse, wet wipe towelette, or spray for removing a wide variety of gram-negative and gram-positive bacteria and other microorganisms from the dental appliance.

### FIELD OF THE INVENTION

This invention relates to dental appliances like mouth guards, night guards, retainers, and orthodontic braces, and more specifically to cleaning products used to kill bacteria and other microorganisms growing on such dental appliances, and to deodorize and remove other contaminants, buildups, and stains therefrom.

### BACKGROUND OF THE INVENTION

Mouth guards constitute a protective device for the mouth that cover the teeth and gums in a molded channel to prevent or reduce injury to the teeth, lips, arches, and gums. Originally required for professional boxers in 1920, and extended to child hockey players in the 1970's, mouth guards have subsequently been adopted in a number of other contact and non-contact sports and activities.

Unfortunately, broken teeth, jaw and neck injuries, mouth abrasions, and cut cheeks, lips and tongues are common among athletes. Young men suffer traumatic tooth injuries two to three times more often than young women, and sports-related injuries account for three times the facial and dental injuries caused by violence and traffic accidents. Surprisingly, basketball players suffer an injury potential that is thirteen times greater than that for the more violent game of football. Use of a mouth guard is essential for lowering the risk of dental injuries in sports. Indeed experts estimate that mouth guards prevent over 200,000 dental injuries in the U.S. each year. Just as importantly, mouth guards can also reduce the risk of concussions by 50%.

Night guards are a thin piece of hard plastic made from an impression of the upper and/or lower teeth that is worn particularly at night to protect against grinding and clenching the teeth during sleep. More specifically, it is a device meant for treating temporomandibular joint disorder (“TJD”), which is primarily caused by stress, arthritis, a fracture, or teeth grinding. Thirty-five million people in the U.S. alone are affected by TMJ. Retainers constitute custom-made plastic plates formed along the upper palate of the mouth with a wire that surrounds the perimeter of the teeth. Such retainers are frequently used by orthodontists to hold teeth in position in the jaw before or after dental braces are employed to move the teeth into proper alignment. Most frequently worn by teenagers, many of them choose to remove their retainer while eating, thereby risking misplacement or loss of the device or acquisition of germs in the process.

A particular problem with such dental appliances, particularly mouth guards and vacuum-formed Essix retainers made from relatively soft plastic materials, is bacteria that can frequently grow on the surface areas. Bacteria, yeasts, and molds can grow inside the pores in the plastic surfaces of these dental appliances. Such bacteria and microorganisms include Staphylococcus, Streptococcus, and pneumococcus. Indeed, many users are unaware of these potential health dangers posed by dirty dental appliances, or else falsely assume that anti-microbial plastics employed to manufacture the dental appliances or storage of the dental appliances in cases will prevent the growth of molds and bacteria. A famous study performed by Dr. Thomas Glass with a follow-up test performed by microbiologists at Oklahoma State University detailed the shocking bacterial results of swabbed athletic mouth guards. See General Dentistry (September/October 2007; May 12, 2008).

The reality is that unless the dental appliance is routinely cleaned by the user, these bacteria can cause gum infections and tooth decay. The bacteria can also travel to the lungs to produce molds that cause exercise-induced asthma and other illnesses that an athlete cannot shake during his or her competition season. Bacteria reaching the stomach can produce toxins causing nausea, vomiting and diarrhea. Moreover, if the user has cuts, irritation of the tissue of the mouth during use of the guard can allow germs like Staphylococcus aureus which is methicillin-resistant to enter the bloodstream. In extreme cases, this disease can be fatal. In a personal case involving the inventor's son, a nearly invisible cut in his gum tissue allowed bacteria to enter his bloodstream, thereby causing a severe infection that ate away at the bone and cartilage in the base of his nose. The son required three surgeries and missed two months of school and three-plus months of his sports season.

Methods known in the prior art for cleaning mouth guards and other dental appliances include rinsing them with cool water. Although warm water is much more effective than cool water for cleaning off a number of the bacteria residing on the dental appliances, warm water can damage the structure of the appliance, since they are made from molded plastics. Additionally, depending upon the volume of water used, the results will vary and probably at least 10% of the bacteria will be left, even in a best case scenario. Moreover, water rinses may not remove bacteria trapped inside the pores of the flexible plastic material commonly used in the dental appliances, or else the teeth crevices formed within. Furthermore, water rinses do nothing to remove embedded odors formed by the bacteria on the dental appliance.

Cleaning the dental appliance with soap and warm water can also be employed. Depending upon the time duration and thoroughness of the soap penetration and water rinse, approximately 95% of the bacteria may be removed by this cleaning method. However, again soap and warm water do nothing to remove embedded odors and staining caused by the bacteria from the dental appliance.

Users of night guards and retainers often resort to Efferdent®, Fixodent®, and Polident® denture cleaners, because they are inexpensive and readily available at stores. While it may be more convenient to immerse the night guard or retainer in such a denture cleaner and let it set than to aggressively wash it with soap and water, such denture cleaners still clean only approximately 95% of the surface bacteria from the night guard or retainer. They also will not remove embedded odors and staining. More problematic is the fact that most denture cleaners contain active ingredients like pursulfate, monopersulfate, and ethylenediaminetraacetic acid (“EDTA”), a metal ion chelating agent and blood thinner, which can cause allergic reactions, and even more severe injuries like permanent neurological nerve damage to the user if ingested due to their zinc contents. Such allergic reactions may include tissue damage; rashes, hives, and irritations; gum tenderness; breathing problems; kidney failure; and low blood pressure. These serious incidents arising from the use of denture cleaners have caused the U.S. Food and Drug Administration (“FDA”) to issue a public health alert in 2008, and require denture cleaner products to include a health warning on their packaging.

Other commonly available products on the market used to clean dental appliances include toothpaste and mouthwash. But, toothpaste is only designed by its manufactures to act upon teeth, so it does not work very well on flexible surfaces like mouth guards and night guards, and it contains abrasive ingredients that can damage the plastic material of the guard, and leave behind a gritty residue. Moreover, toothpaste is designed to remove food particles and stains on teeth, not bacteria and other germs per se. Mouthwashes, on the other hand, may be designed in part to kill bacteria that cause gingivitis along the user's gum-lines. But, the chemical additives incorporated into mouthwash formulations do not necessarily kill other types of bacteria that commonly build up on dental appliances, and they need to contact bacteria laden surfaces for fairly substantial time periods in order to be effective. Additionally, neither of these methods are effective in the removal of stains and buildup on the plastic materials that these guards are made of, and as a result they do not address the most obvious and concerning issue to the guard user—the awful odor.

Because mouth guards are frequently attached by straps to football, lacrosse, and hockey helmets, it is doubtful that many athletes take the trouble to detach them in order to thoroughly clean them with soapy water or denture cleaners. Moreover, such helmets are often stored along with the attached mouth guards in dark, dank equipment bags where the mouth guards come into contact with other athletic equipment and gain even more bacteria. Furthermore, mouth guards often are chewed by athletes which not only destroys their protective fit along the teeth, but also creates rough surface areas for bacteria growth. Indeed, the porous materials used in mouth guards to provide their shock absorbent flexibility also contributes numerous pockets in which bacteria can grow.

Another approach taken by dental appliance users is an ultra-violet based cleaning system, such as the CLEAN-GUARD system. Originally designed as a toothbrush cleaner, it uses sonic waves and UV light. But, this product breaks down the plastics used in dental appliances, and test users have discovered that it does nothing to address staining on the dental appliance. Indeed, the UV light has even seemed to increase the foul odor of the guard. Additionally, this type of product is expensive, takes time to operate, and can become inoperative if its batteries lose their energy. Moreover, once the original batteries die, the cleaner unit, itself, frequently becomes an unhealthy environment for bacteria growth, because it has become a storage case, instead of a cleaning device. Meanwhile, the SONIC BRIGHT system marketed for dentures, orthodontic retainers, invisible braces, and oral prosthetics is a chemical-based system utilizing similar harsh chemical ingredients such as the persulfates, persulfates and EDTA, and sodium monopersulfates used in denture cleaners. These chemicals can also be harsh on the flexible composite materials used to manufacture mouth guards, as well as breaking down the metal welds on retainers.

Ascorbic acid (i.e., Vitamin C) is known to be a disinfectant that can kill various pathogenic microorganisms. Some studies suggest that ascorbic acid can be effective for inactivating certain viruses like the polio virus, Herpes virus, vaccinia virus, and hepatitis virus. The intracellular replication of rhino virus, Rous Sarcoma virus, and human T cell leukemia virus have been suppressed by ascorbic acid. There is even evidence that ascorbic acid may inhibit the activity and growth of the AIDS virus (HIV). See U.S. Pat. No. 5,631,001 issued to Harich.

Jacob Harich conducted research in the 1960's and 1970's to identify possible uses for the unwanted pulp of Florida citrus crops. He discovered that grapefruit pulp at a pH of 2.5-5.0 could be extracted by propylene glycol or glycerin in a 1:2 ratio at elevated temperatures and in the presence of UV light to yield a reaction product useful in cosmetics, shampoos, and lotions. See U.S. Pat. No. 3,890,212 issued to Harich et al. This product was also demonstrated to have some anti-bacterial properties against Staphylococcus aureus gram positive and gram negative cultures inoculated on the surface of test plates in the laboratory. See U.S. Pat. No. 4,021,548 issued to Harich et al.

Twenty years later, Dr. Harich determined that the potency of his anti-microbial product for food preservation could be enhanced with the addition of grapefruit seed to the grapefruit pulp. Called grapefruit seed extract (“GSE”), an 80:20 mixture of grapefruit seed and grapefruit pulp was extracted with an equal weight amount of glycerin at a temperature of at least 150° C. for 3-4 hours, followed by continued extraction at 60° C. at an elevated 2,500-3,000 psi pressure to produce a heavy viscous, lemon yellow syrup reaction product. Containing approximately 16.5% ascorbic acid, 14-15% bioflavonoids, and 30% glycerin, this product was tested as a disinfectant on bacteria, yeast, and fungi transferred to stainless steel cups, glass rods, and cotton swabs. At a 1:100 dilution level, the GSE disinfectant killed 100% of the microorganisms on the hard surfaces of the cups and glass rods after 1-2 hours of immersion, and two or more hours of immersion for the cotton swabs. At a higher dilution of 1:1000, an immersion time frame approaching 24 hours was required to kill 100% of the microorganisms for the three test substrates. See U.S. Pat. Nos. 5,425,944 and 5,631,001 issued to Harich et al.

Other researchers have tested GSE in the laboratory environment to determine the GSE concentration necessary to kill gram-positive and gram-negative bacteria. For example, L. Regor et al., “The Effectiveness of Processed Grapefruit-Seed Extract As An Antibacterial Agent: I. An In Vitro Agar Assay,” J. of Alternative and Complementary Medicine, vol. 8, no. 3, pp. 325-32 (2002) reported the testing of CITRICIDAL® GSE as an inoculant against 67 distinct bio-types of bacteria grown in wells punched into Mueller-Hinton agar plates. After an overnight incubation period, the researchers discovered that the GSE was consistently anti-bacterial against all of the biotypes tested, and was comparable to other proven topical antibacterial agents like SILVA-DENE®, SULFAMYLON®, BACTRO BAN®, NITRO FURAZONE®, and NYSTATIN®. This test suggested that GSE might hold promise as a topical antibacterial agent.

Another research study reported by Heggers et al., “The Effectiveness of Processed Grapefruit-Seed Extract as an Antibacterial Agent: II. Mechanism of Action and In Vitro Toxicity,” J. of Alternative and Complementary Medicine, vol. 8, no. 3, pp. 333-40 (2002) attempted to identify safe concentrations for GSE used as an antibacterial agent, since GSE can be toxic to tissue cells at higher concentrations. CITRICIDAL-brand GSE was diluted with sterile water at a number of concentrations over a 1:1-1:512 range. Sheep Blood and MacConkey agar plates inoculated with a variety of gram-positive and gram-negative organism were treated with the GSE diluted solutions at the various concentrations, and allowed to incubate overnight. The results demonstrated GSE's potency to gram-positive and gram-negative organisms, including antibacterial effects at a concentration as dilute as 1:512. This low concentration is non-toxic to human skin fibroblasts.

But, research tests conducted within laboratory settings on microorganisms grown in agar plates do not necessarily prove that GSE can be effective as an antibacterial agent for actual in-field environments, including dental appliances. Other research is necessary to establish the efficacy of GSE for treating bacteria in such environments. For example, U.S. Pat. No. 7,485,110 issued to Koenig et al. teaches a wet wipes product incorporating a combination of a urase-inhibiting solution including Yucca schidigera extract, and a broad spectrum antimicrobial. These wet wipes were effective for reducing gram-negative bacterial like E-coli and candida albicans on skin that can cause diaper rash and skin irritation without interfering with gram-positive bacteria.

U.S. Pat. No. 7,485,259 issued to Eldred covers a portable water-treatment agent containing Cu⁺² and Ag⁺² metal cations, GSE, and glycerin alcohol. This product is utilized as an alternative to chlorine to disinfect water for bottled water products or public, stored, or emergency water systems.

U.S. Published Application 2005/0180930 filed by Abiru discloses an antimicrobial dental composition for a user's teeth and gums. Applied by a toothbrush, this composition contains a powder made from GSE or persimmon juice extract, as well as cyclodextrin. U.S. Pat. No. 6,706,256 issued to Lawlor teaches an oral care composition comprising an antibacterial seed or pulp extract sourced from citrus or vitis plants like grapefruit, orange, lemon, lime, tangerine, mandarin, Satsuma, Clementine, citron, shaddock, grape, or a mixture thereof, in combination with an oral care active selected from the group consisting of anti-calculus agents, anti-plaque agents, fluoride ions, desensitizing agents, malodor control agents, H₂ antagonists, or metal cations. Such oral care composition can adopt the form of a mouth rinse, chewing gum, lozenge, oral gel, toothpaste, or dentifrice. But, these oral care active agents have been shown to be hazardous to the human body when ingested. Furthermore, Lawlor's product is directed solely to controlling oral malodor (i.e., bad breath) instead of being directed to dental appliances like mouth guards, night guards, and orthodontic retainers and braces. Indeed, many of the components incorporated into Lawlor's oral care product are actually harmful to both the dental appliance and the human body. Lawlor was also concerned primarily with bacteria that cause bad breath. Such bacteria are much more benign than the virulent bacteria that grow on dental appliances.

Moreover, these prior art patents seem to teach that GSE, but itself, cannot work in a real-world environment to kill bacteria. Instead, something else must be included in antimicrobial compositions in combination with the GSE to kill or reduce microorganisms, whether it be metal cations, ascorbic acid, cyclodextrin, or other broad-spectrum antimicrobials. The prior art suggest that this particularly is the case for oral care products.

Acetic acid (i.e., vinegar) has been used as a general-purpose cleaner since time immemorial. It will clean grime off windows, lime scale off faucets, oxidation off copper pans. It is also good for removing stains from coffee and teacups. Acetic acid will deodorize as well. It can serve as an effective anti-bacterial cleaning agent used on hard surfaces like bathroom tiles and countertops, perhaps more due to the wiping action than any chemistry. However, while acetic acid has been used in homeopathic remedies since Hippocrates to fight infections, medical studies show that whether it is taken internally or applied topically, acetic acid is not effective against infections, lice, or warts. Although it is popularly surmised that vinegar has antimicrobial properties, H.J. Heinz, the largest manufacturer of vinegar, has never made such a claim in the marketing of its product. This may be due to the fact that acetic acid would need to exceed 10% in concentration to act as a herbicide or pesticide against microorganisms. Yet, household acetic acid is commonly restricted to a 5% concentration of 5% or less in order to avoid injuries to humans.

A plant extract-based product for cleaning dental effective appliances like mouth guards and night guards with highly effective antimicrobial properties against a wide variety of gram-negative and gram-positive bacteria without the inclusion of additional antibacterial agents would be beneficial. Moreover, the product should remove odors and scale buildup from the dental appliance as well. Such products including, e.g., GSE should be a natural and safe for the user, gentle on the materials used to manufacture the dental appliance, and easy to apply to the dental appliance as a rinse or convenient topical wipe.

### SUMMARY OF THE INVENTION

The present invention provides an antimicrobial composition for conveniently cleaning dental appliances like athletic mouth guards, night guards, orthodontic retainers and Invisalign-style braces, and teeth whitening trays of harmful germs, bacteria, molds, odors, and stains. Such composition comprises a plant-based anti-microbial extract like. GSE in combination with a cleaning agent without the need for additional ascorbic acid or metal cation-based antibacterial agents. The cleaning composition can take the form of a rinse for removing a wide variety of gram-negative and gram-positive bacteria and other microorganisms from the dental appliance immersed therein within a relatively short time period. Alternatively, the cleaning composition can be incorporated into a disposable wet wipe towelette for convenient topical cleaning of bacteria or other microorganisms from the surface of the dental appliance. It can also be delivered to the dental appliance in a spray form. This antimicrobial cleaning composition provides a safe and natural way for children and adults to remove such microorganisms, stains, and odors from the dental appliance surfaces with maximum convenience, thereby promoting the health of the end user of the dental appliance.

### BRIEF DESCRIPTION OF THE DRAWINGS

In the accompanying drawings:

FIG. 1 is a perspective view of the lower side of an athletic mouth guard.

FIG. 2 is a perspective view of an antimicrobial dental appliance cleaning rinse kit of the present invention for removed harmful microorganisms from the surface of dental appliances.

FIG. 3 is a perspective view of the storage case of the cleaning kit opened to show the mouth guard contained therein.

FIG. 4 is a perspective view of a packaged antimicrobial dental appliance wet wipes towelettes product of the present invention for removal of harmful microorganisms from the surface of dental appliances.

FIG. 5 is a schematic view of one embodiment of the packaged wet wipes towelettes for the antimicrobial cleaning product of FIG. 4.

FIG. 6 is a schematic view of another embodiment of the packaged wet wipes towelettes for the antimicrobial cleaning product of FIG. 4.

FIG. 7 is a schematic view of still another embodiment of the packaged wet wipes towelettes for the antimicrobial cleaning product of FIG. 4.

### DETAILED DESCRIPTION OF THE PREFERRED EMBODIMENT

An antimicrobial composition for conveniently cleaning dental appliances like mouth guards, night guards, and orthodontic retainers and braces of harmful bacteria and other microorganisms is provided by this invention. Such composition comprises a plant-based anti-microbial extract like GSE in combination with a cleaning agent without the need for additional ascorbic acid or metal cation-based antibacterial agents. The cleaning composition can take the form of a rinse for removing a wide variety of gram-negative and gram-positive bacteria and other microorganisms from the dental appliance immersed therein within a relatively short time period. Alternatively, the cleaning composition can be incorporated into a towelette for convenient topical cleaning of bacteria or other microorganisms from the surface of the dental appliance. The antibacterial composition of the present invention contains only natural ingredients for cleaning harmful microorganisms from the dental appliance, while also removing foul odors and scale buildups without any harmful chemicals that might degrade or harden the plastic or metal materials used in the dental appliance. The cleaning composition is also safe to the user when it exists as a residue on the dental appliance after the cleaning process, or even if swallowed. All of the ingredients of such products should preferably fall under the umbrella approval of the FDA, as being considered “generally recognized as safe” (“GRAS”), meaning that all of the ingredients are generally recognized by qualified experts as being generally safe under the Federal Food, Drug and Cosmetic Act.

For purposes of this invention, “dental appliance” means any contraption worn by the user in the mouth to protect or treat the teeth and gum line including, without limitation, mouth guards, night guards, orthodontic retainers, and orthodontic braces.

As used within this application, “mouth guard” means a protective device for the user's mouth that covers the teeth and gums in a molded channel therein to prevent injury to the teeth, lips, arches, gums, and concussion prevention. Such mouth guards are commonly used and required for a wide variety of contact and non-contact sports and activities including without limitation acrobatics, baseball, basketball, bicycling, boxing, equestrian events, field events, field hockey, football, gymnastics, handball, ice hockey, in-line skating, lacrosse, martial arts, racquetball, rugby, shot-putting, skateboarding, skiing, skydiving, soccer, softball, squash, surfing, volleyball, water polo, weightlifting and wrestling.

In the context of the present invention, “plant-based antimicrobial extract” means any natural substance naturally extracted from the seeds, pulp and/or fruit of a Citrus, Vitis, or other plant that exhibits properties for impeding the growth of, reducing, or eliminating the incidence of gram-negative bacteria or gram-positive bacteria or other microorganisms upon contact, including without limitation those obtained from the plant group consisting of bergamot or bitter orange (Citrus aurantiums); grapefruit (Citrus Grandis, Citrus Paradisi); orange (Citrius Sinesis); lemon (Citrius medica limonium, Citrus limon); lime (Citrus aurantifolia); tangerine (Citrus reticulata); mandarin (Citrus reticulata); satsuma (Citrus reticulata); clementine (Citrus reticulata); citron (Citrus medica); shaddock (Citrus maxima); grape (Vitis vinifera); and mixtures thereof.

As used within this application, “allergy-inducing agents” means any chemical or other substance which upon ingestion or topical contact can cause the user to suffer an allergic reaction, such as inflammation, hives, skin irritation, itching, wheezing, anaphylaxtic swelling, nausea, diarrhea. Such agents include without limitation sodium monopersulfate, sodium perborate, persulfates, or EDTA.

In the context of this invention, “microorganisms” means any microscopic single or multi-cell organism found in nature, including without limitation, bacteria, yeasts, germs, molds, and viruses.

For purposes of this invention, “safe and effective amount” means an amount of a plant-based antimicrobial extract or other antimicrobial compound or component sufficient to significantly induce a positive benefit, but low enough to avoid a serious side effect in the user—that is, to provide a reasonable benefit to risk ratio within the scope of sound medical judgment.

The antimicrobial dental appliance cleansing composition of the present invention comprises: (i) an effective amount of at least one plant-based antimicrobial extract compound; (ii) a cleaning agent selected from the group consisting of an alpha hydroxy acid, hydrogen peroxide, denatured alcohol, ethanol, or mixtures thereof; and (iii) optional agents in the form of carriers, stabilizers, colorants, flavorants, or naturally-derived deodorizors, such components of this antimicrobial cleaning composition acting in combination to reduce or eradicate the presence of microorganisms and stains or odors from the surface of the dental appliance upon topical application without the inclusion of any anti-microbially effective amount of ascorbic acid or any metal cation, or allergy-inducing agent, anti-calculus agent, anti-plague agent, fluoride ion source, desensitizing agent, H₂ antagonist, or chemically derived malodor control agent.

For purposes of this invention, “alpha hydroxy acid” means a class of chemical compounds that consist of a carboxylic acid substituted with a hydroxyl group on the adjacent carbon atom. They may be either naturally occurring or synthetically produced. Such alpha hydroxy acids include acetic acid, glycolic acid, lactic acid, and citric acid.

As used in this application, “chemically-derived malodor control agent” means chemically produced antimicrobial agents like 5-chloro-2-(2,4-dichlorophenoxy)-phenol (commonly known as Triclosan); phthalic acid and its salts like magnesium mono-potassium phthalate, including but not limited to those disclosed in U.S. Pat. No. 4,994,262; chlorhexidine; alexidine; hexetidine; sanguinarine; benzalkonium chloride; salicylanilide; domiphen bromide; cetylpyridinium chloride; tetradecylpyridinium chloride; N-tetradecyl-4-ethylpyridinium chloride; octenifine; delmopinol; octapinol; and other piperidine derivatives; nicin preparations; zinc/stannous ion agents; antibiotics such as augmentin, amoxicilline, tetracycline, doxycycline, minocycline, and metronidazole; and analogues and salts of the above; methyl salicyclate; and mixtures of all of the above.

The principal antimicrobial agent for the dental appliance cleaning composition of the present invention is at least one plant-based antimicrobial extract compound. Such compounds are selected from the plant groups consisting of bergamot or bitter orange (Citrus aurantiums); grapefruit (Citrus Grandis, Citrus Paradisi); orange (Citrius Sinesis); lemon (Citrius medica limonium, Citrus limon); lime (Citrus aurantifolia); tangerine (Citrus reticulata); mandarin (Citrus reticulata); satsuma (Citrus reticulata); clementine (Citrus reticulata); citron (Citrus medica); shaddock (Citrus maxima); grape (Vitis vinifera); and mixtures thereof. Such antimicrobial plant-based extract compound is preferably selected from the grapefruit family, more preferably from the seeds and/or pulp of harvested grapefruits, otherwise known as grapefruit seed extract (“GSE”). However, any of the other Citrus or Vitis plant families identified above may be used for purposes of producing the extract material for the antimicrobial plant-based extract compound within the scope of this invention. Moreover, mixtures of the seed and pulp extract derived from a single plant family type may be used, as may mixtures of seed and/or pulp extract material derived from two or more plant family types.

While not wanting to be bound to any particular theory of invention, it is believed that the polyphenol materials found in the seed or pulp extract derived from the Citrus or Vitis plant family provide the active component for the antimicrobial plant-based extract compound. Such phenol groups constitute aromatic six member carbon rings to which is bonded at least one alcohol group, and more than one, preferably more than two such phenol groups should be present in the extract compounds. GSE, for example, is believed to comprise the polyphenols quertcitin, quercetin glycoside, halperidin, campherol glycoside, apigenin, rutinoside, hepamothoxyflavone, and dihydrocampherol glycoside, which are stabilized by being converted to ammorium salts in the extract mixture. The flavonoids narigin, isocurametin, neohesperidin, hesperidin, poncirin, nebiletin, and tangeretin are also present which may likewise provide some active antimicrobial activity.

The pulp of the grapefruit at a pH of 2.5-5.0 should be reacted with an alcohol or ketone, preferably propylene glycol or glycerin, for a time period of about 6-24 hours preferably at a temperature of about 90-140° F. to produce a reaction mixture. This reaction mixture is subjected to ultraviolet radiation from an ultraviolet light source to yield the grapefruit pulp extract, as disclosed more fully in U.S. Pat. Nos. 3,890,212 and 4,021,548 issued to Harich et al. In a more preferred embodiment, GSE product may be made from an 80:20 mixture by weight of grapefruit seed and grapefruit pulp which have been dried for 24-48 hours at a temperature range of 150-200° C. This seed/pulp mixture is then ground in a hammer-mill to small particle size. An approximately equal by weight amount of glycerin solution is added to the grapefruit seed/pulp particle mixture and heated to a temperature of at least approximately 150° C. with the glycerin solution being pumped through the grapefruit seed/pulp particle mixture in the presence of ultraviolet radiation at the same temperature for approximately 3-4 hours. The temperature of the reaction vessel is then reduced to approximately 60° C. with the pressure increased to 2,500-3,000 psi. The resulting syrup is filtered to yield a heavy viscous lemon yellow liquid having a pH range of 2.5-3.0 which constitutes the GSE product. This manufacturing process is disclosed in greater detail in U.S. Pat. Nos. 5,425,944 and 5,631,001 issued to Harich et al. The preferred embodiment of GSE for the antimicrobial plant-based extract compound used in the antimicrobial dental appliance cleaning composition of the present invention constitutes CITRACIDAL® GSE commercially available from Biochem of Lakeport, Calif., also known commercially as NUTRIBIOTIC.® This NUTRIBIOTIC product contains approximately 33 wt % CITRICIAL GSE and 67 wt % vegetable glycerin.

The cleaning agent component of the antimicrobial dental appliance composition of the present invention is selected from the group consisting of an alphahydroxy acid, hydrogen peroxide, denatured alcohol, ethanol, or mixtures thereof. Such alphahydroxy acid can take the form of acetic acid, lactic acid, glycolic acid, or citric acid. Preferably, it should constitute acetic acid. It is commonly available in the market as “vinegar” when the concentration of the acetic acid solution is approximately 5 wt % or less. However, glacial acetic acid typically constitutes a nearly 99.5% pure concentration of acetic acid, and is preferred because of its higher concentration for purposes of formulating the antimicrobial dental appliance composition of the present invention. Glacial acetic acid is commercially available from Spectrum Laboratory Products, Inc. of Gardena, Calif.

Hydrogen peroxide can also be used as the cleaning agent component for the antimicrobial dental appliance cleaning composition of the present invention. Hydrogen peroxide (H₂O₂) is an oxidizer commonly used as a bleach. It is a clear liquid that is slightly more viscous then water. However, a cosmetic solution form of hydrogen peroxide that contains 50.1-50.9 wt % hydrogen peroxide, preferably about 50.2 wt %, may be sourced from FMC Corporation of Philadelphia, Pa., and is safe when ingested, if diluted to approximately 0.1-1.0 wt % or less. It will naturally break down into hydrogen and oxygen. It should not be used as a cleaning agent where the dental appliance to be treated with the antimicrobial cleaning composition of the present invention contains any aluminum steel wires and other parts. However, stainless steel wires and other parts commonly used in orthodontic retainers and braces will not be damaged by exposure to hydrogen peroxide.

Denatured alcohol, which constitutes a substitute for nearly 200-proof ethanol, is another cleaning agent that can be employed in the antimicrobial dental appliance cleaning composition of the present invention. Because the government taxes high-proof ethanol as a potential alcoholic beverage, denatured alcohol has additives like methanol, isopropyl alcohol, acetone, methyl ethyl ketone, methyl isobutyl ketone, or denatonium incorporated into the ethanol to render it more likely to make a person sick and therefore undrinkable. Denatured alcohol will not attack metal parts incorporated into the dental appliance, and it can substitute for a portion of the acetic acid which could otherwise under some circumstances corrode or damage metal surfaces. It may also be possible to surmise that the glycerin component in the GSE or other antimicrobial plant-based extract compound will soften the plastic materials used in the dental appliance to render it safe from alcohol attack. 190-proof SDA 40B ethyl alcohol is appropriate for purposes of this invention and can be sourced from Grain Processing Corporation of Mascatine, Iowa.

The antimicrobial dental appliance cleaning composition of the present invention can include additional ingredients such as carriers, stabilizers, solubilizers, colorants, flavorants, and naturally-derived deodorizors. For purposes of the rinse format of the antimicrobial dental appliance cleaning composition, the carrier is preferably water. Such water should preferably be of low ion content and free of organic impurities. This amount of water in the composition can constitute not only free water, but also water that is introduced with other ingredients, such as the acetic acid solution, flavorant solution, and colorant solution.

A flavorant may also be incorporated into the antimicrobial dental appliance cleaning composition. A wide variety of such flavorants are known in the industry. They include synthetic flavors and/or oils and or essences derived from plants, roots, beans, nuts, leaves, flowers, fruit, etc. and mixtures thereof. Examples of suitable flavors include lemon, orange, banana, grape, lime, apricot, grapefruit, apple, strawberry, cherry, peppermint, chocolate, pineapple, coffee, cocoa, cola, peanut, almond, liquorice, cinnamon, etc. A preferred form of this flavorant agent is peppermint oil, such as Oil Peppermint Natural P0003 sourced from Ungerer & Company of Lincoln Park, N.J. The flavoring agent can be used in an amount up to 4 wt %, preferably 0.1-1.0 wt %. This flavorant serves the function of making the taste of the antimicrobial dental appliance cleaning composition more appealing to the user of the dental appliance after its surface has been topically treated by the composition.

Another purpose of the flavorant is to serve as a natural deodorizer of the dental appliance. Dental appliances tend to collect residue buildups from the user's mouth over time. Some of these residues can lend a foul odor to the dental appliance. A natural deodorizer like peppermint oil will mask these odors, and make the dental appliance more palatable to the user. Other natural deodorizers that are useful for the composition of this invention include extracts obtained from the tea, honey suckle, gold thread, or magnolia plants, cinnamon, spearmint, citrus oil, or mixtures thereof.

A coloring agent will improve the color and visual appearance of the antimicrobial dental appliance cleaning composition of the present invention, particularly the uniformity of its appearance. Such colorant may be in the form of an aqueous solution, preferably 1 wt % coloring agent in a solution of water. Color solutions generally comprise 0.01-5.0 wt % of the antimicrobial dental appliance cleaning composition. Examples of such coloring agents include food colorings like FD&C Blue #1, FD&C Blue #2, FD&C Yellow #5, FD&C Yellow #6, and FD&C Red #40, as well as orange, lemon yellow, green, and caramel colors. A preferred colorant is FD&C Blue #1 colorant sourced from Science Lab.com, Inc. of Houston, Tex.

A stabilizing agent is useful for stabilizing the presence of the colorant and flavorant/deodorizer agent within the antimicrobial dental appliance cleaning composition, so that they do not separate out of the composition mixture or lose their desirable properties. Such stabilizers include sorbic acid, calcium benzoate, erythorbic acid, and sodium erythorbate. A preferred stabilizing agent is a mixture of sodium benzoate and potassium sorbate Sodium Benzoate EDF constitutes 99.0-100.5 wt % C₇H₅NAO₂ and may be sourced from Tianjin Dongda Chemical Industrial Co. Ltd. of China. Potassium sorbate constitutes 98.0-101.0 wt % C₆H₇K0₂ on a dry basis, and may be sourced from Hangzhou Sanhe Food Co. Ltd. of Hangzhou, China.

A solubilizer like PEG-40 hydrogenated castor oil will function to solubilize the peppermint oil within the antimicrobial dental appliance cleaning composition. A commercially-available example of such PEG-40 hydrogenated castor oil is Cremophor® RH40 sourced from BASF Corporation of Germany.

A preferred embodiment of the antimicrobial dental appliance cleaning composition of the present invention is shown below in Table 1, along with the range and preferred range of each ingredient:

TABLE 1

| | | Preferred Range |
|---|---|---|
| Ingredient | Range (wt %) | (wt %) |
| Deionized water | Q.S. 100% | Q.S. 100% |
| Glycerin (99.9% U.S.P.) | 0.5-50.0 | 2.0-20.0 |
| Glacial acetic acid | 0.1-2.5 | 0.3-1.0 |
| Grapefruit seed extract (GSE) | 0.25-5.0 | 0.5-2.5 |
| Sodium benzoate/potassium sorbate | 0.1-1.5 | 0.5-1.0 |
| PEG-40 hydrogenated castor oil | 0.0-5.0 | 0.5-1.5 |
| Natural peppermint oil | 0.0-5.0 | 0.2-1.0 |
| Blue #1 Aqueous solution (0.1 wt %) | 0.0-0.5 | 0.005-0.1 |
| | 100.00 | 100.00 |

This particular formulation is meant to exemplify the invention without limiting it in any manner. Many alternative formulations using different concentrations of the ingredients or different ingredients are possible without departing from the scope of this invention.

The process for preparing the antimicrobial dental appliance cleaning composition is simple and straightforward. The additional glycerin and glacial acetic acid are added to the deionized water in a tank and mixed. Next, the GSE product (containing ⅓ GSE and ⅔ glycerin, as produced by NutriBiotics) is added to the mixture and thoroughly mixed. Next, the sodium benzoate and potassium sorbate stabilizer admixture is added to the composition mixture, along with the Blue #1 coloring agent. The PEG-40 hydrogenated castor oil solubilizer and the natural peppermint flavorant/deodorizer are mixed separately together and then added to the overall mixture. The composition is thoroughly mixed in the tank by means of an impeller mixer at room temperature. The resulting antimicrobial dental appliance cleaning composition may be stored at room temperature, and will remain stable, ready for use with an extended shelf life of up to three years.

Another example of formulations for antimicrobial dental appliance cleaning compositions under this invention are shown in Table 2:

TABLE 2

| Ingredient | Wt % |
|---|---|
| Deionized water | Q.S. 100% |
| Additional Glycerin (99.9% U.S.P.) | 5.0 |
| Alphahydroxy acid | 0.5-5.0 |
| Grapefruit seed extract (GSE) product | 1.0 |
| containing glycerin | |
| Sodium benzoate/potassium sorbate | 0.250 |
| PEG-40 hydrogenated castor oil | 2.216 |
| Natural peppermint oil | 0.044 |
| Blue #1 Aqueous solution (0.1 wt %) | 0.100 |
| | 100.00 |

As mentioned above, another alpha-hydroxy acid like lactic acid, glycolic acid, or citric acid, may be used instead of acetic acid, but acetic acid is preferred as the cleaning agent for its deodorizing properties and dental appliance stain cleaning capabilities. In combination with GSE, it is believed to provide an effective boost to the antimicrobial properties of the final cleaning composition.

While not wanting to be bound by any particular theory of the invention, it is believed that the plant-based antimicrobial extract agent like GSE in the composition acts to reduce the incidence of or eradicate microorganisms from the surface of the dental appliance, while the cleaning agent like acetic acid acts to remove stains and odors from the surfaces of the dental appliance. But these two components are believed to act synergistically with each other. By the cleaning agent acting to remove stains and odors from the dental appliance, the plant-based extract can gain better access to the microorganisms to reduce or eradicate them from the dental appliance surface.

Of great significance to the antimicrobial dental appliance cleaning composition of the present invention is what it does not include. The composition does not include additional antimicrobial agents like ascorbic acid (Vitamin C) or metal cations, as is required by other oral care products known in the industry containing GSE. Ascorbic acid is a sugar acid with antioxidant properties that is known for treating diseases like scurvy. The anti-microbial dental appliance cleaning composition of the invention has proven to have very efficacious antimicrobial properties through the plant-based extract without the addition of ascorbic acid.

Metal cations have been included in other oral care products on the market to increase the effectiveness of antibacterial properties, and in an effort to fight oral malodor. They often utilize silver, copper, or zinc—all of which are proven to have adverse affects on the human body. Many products containing zinc are currently being removed from the market place and many others are being forced to include warning labels on their products. EDTA is added to products as a chelating agent to assist in reducing the amount of absorption into the body. The antimicrobial cleaning product of the present invention foregoes such metal cations while achieving a highly desirable level of antimicrobial activity for treating dental appliances through the plant-based extract.

The antimicrobial dental appliance cleaning composition of the present invention also omits any anti-calculus agents, anti-plaque agents, fluoride ion sources, desensitizing agents, H₂ antagonists, or chemically-derived malodor control agents found in other oral care products found in the prior art.

Anti-calculus agents like phosphate, pyrophosphate, polyphosphate, phosphonate, polyphosphonate, and aluminum compounds are common ingredients found in dental care products. They are used to fight microorganisms found in the mouth that cause tooth decay.

Anti-plaque agents are any substances that inhibit the accumulation of bacterial deposits on the surfaces of gum lines and oral cavities. Examples found in the prior art of such anti-plaque agents include xylitol, ammonium fluoride, chlorothymol, stannous fluoride, and urea peroxide.

Fluoride is used in almost all dental related products for the purpose of protecting teeth from decay. However, just like so many good intensions, over exposure by users to fluoride has been found to cause adverse effects. Fluoride is known to be more toxic than lead and slightly less toxic then arsenic. Fluoride powder was once used to kill lice and is the main ingredient found in rat bait stations. Additionally a large percentage of ingested fluoride is retained in the body and stored in the bones, thereby causing adverse effects on teeth and bones as well as soft tissue damage, such as increased fracture, poor fracture healing, neurological lesions, thyroid dysfunction, heart disease even higher infant death rates due to congenital abnormalities and higher death rates in prevalent fluorosis areas. Based on a study of 43 million Chinese people within the Fluorosis area, as well as a US Journal of American Medical Association study conducted by Dr. S. J. Jacobsen and Christa Danielson in 1990 and a follow-up study conducted in 1992 investigating the higher incidence of hip fractures in residents of public fluorinated drinking water systems.

Desensitizing agents are also present in many commercial oral care products. They act as anti-pain agents for topical treatment of sore gums and inner cheeks. Examples include strontium chloride, potassium nitrate, natural herbs like gall nut, asarum, cubebin, Galasega, and low levels of non-steroidal anti-inflammatory agents. Potassium nitrate is a chemical that is known to cause harmful effects when ingested, including irritation, swelling and redness to the skin and eyes and can damage the respiratory system.

Many oral care products known in the industry also incorporate chemically-derived malador control agents for fighting microorganisms in the user's mouth that cause, e.g., halitosis (“bad breath”). Such commonly known oral malador control agents include triclosan, phthalic acid and its salts, magnesium mono-potassium phthalate, chlorhexidine, sanguinarine, benzalkonium choloride, salicylanilide, domiphen bromide, and tetradecylpyridinium chloride (“TPC”).

Triclosan is an ingredient found in many detergents, dish-washing liquids, soaps, deodorants, cosmetics, lotions, anti-microbial creams, various toothpastes, and an additive in various plastics and textiles. Recent concerns have arisen regarding to the harmful environmental and human health effects of tricolosan. Manufactures of products which containing triclosan maintain that it is safe, however, the United States EPA has registered it as a pesticide. Strong antibiotic agents such as triclosan used regularly have raised concerns of toxic results by utilizing such broad-scale killing of all microscopic organisms, to which they are applied. This process creates a risk of toxicity to host organisms, that is, the plants, humans and animals exposed to treatment for microbial infections. Toxic exposure to humans can also occur when food items and objects such as utensils or hard surfaces are treated with disinfectants for microbial contamination. Additionally, this broad approach destroys not only the bad bacteria but also the beneficial bacteria, which occur naturally in the environment and in our bodies. These good bacteria produce a beneficial effect such as aiding metabolism (studies have shown triclosan blocks health metabolism of the thyroid hormone) and inhibit the invasion of harmful pathogens. Recent studies have shown that overuse of anti-microbial formulas and disinfectants can also cause genetic mutations resulting in drug-resistant bacterial and mutant viruses, producing new strains of harmful microbes for which the human immune system has no defense.

Other additives found in prior art oral care products include parabens and sodium laury/sulfate (“SLS”). Parabens are widely used in cleaning products as preservatives. But, they may cause contact dermatitis in some individuals

SLS is used as a lathering agent. This chemical is a known skin irritant. It also enhances the allergic response to other toxins and allergens. The U.S. government has warned manufacturers of unacceptable levels of dioxin formation in some products containing this ingredient. SLS can react with other ingredients to form cancer-causing nitrosamines.

Perhaps, because of the allergic side effects of many of these additives found in oral care products in the industry, manufacturers have also incorporated H₂ antagonists. They are compounds that block H-2 receptors that can otherwise lead to skin irritation, redness, swelling, and anaphylactic side effects.

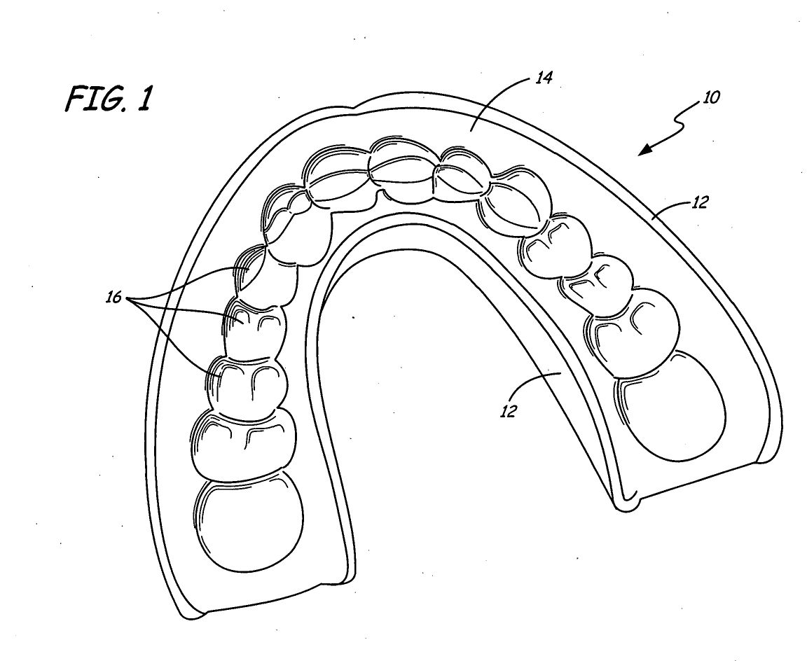

The antimicrobial dental appliance cleaning composition of the present invention can be provided to the end user in the form of a liquid cleansing rinse or soaking solution. A mouth guard 10 is shown in FIG. 1. Meant to be worn by a user around, typically, the upper line of teeth, it comprises an exterior u-shaped body 12 containing a thermally-moldable plastic material 14 in which the user's teeth have been inset to form an imprint 16 therein for each tooth. When the mouth guard 10 is placed into the user's mouth and along the upper gum line, the user's teeth enter these imprint channels 16 so that the mouth guard may fit closely around the teeth and gum line to provide maximum protection. Note that some athletes, such as weight lifters, wear mouth guards on the lower teeth line, and the antimicrobial cleaning composition of this invention applies equally, well to cleaning such lower teeth line mouth guards.

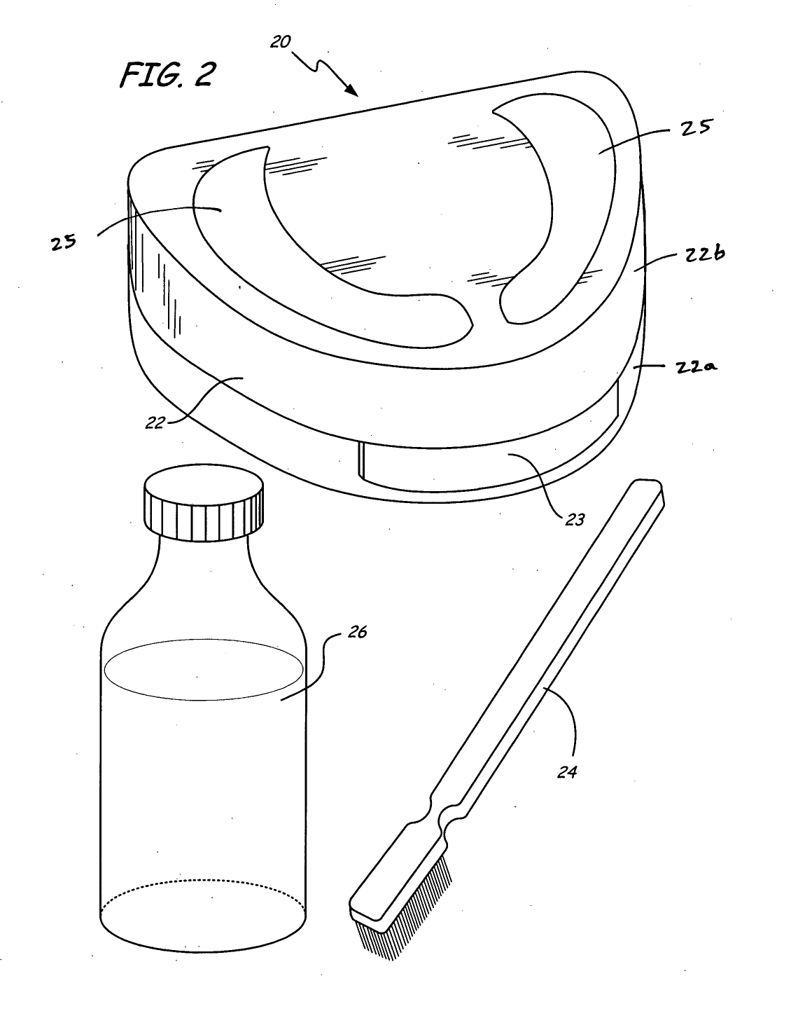

As shown in FIG. 2, a cleaning kit 20 comprising this invention includes a protective case 22 for holding the dental appliance such as the mouth guard 10, a mini soft bristled brush 24, and a bottle 26 containing the antimicrobial cleaning composition. The case 22 can be made from any appropriate cleanable material including plastic, ceramic, glass, or metal. The case 22 contains a housing 22a and lid 22b which is hinged to the housing along its one edge (not shown) and releaseably secured to the housing along another edge by means of clasp 23. Alternatively, the lid housing 22b may contain a lip extending around its perimeter which cooperates with a rabbit groove extending around housing 22a so that the lid can be conveniently snap fitted onto the housing. The lid may also feature optional vents 25 for allowing air to circulate into the case containing the mouth guard to remove moisture that can produce unhealthy molds and other microorganisms.

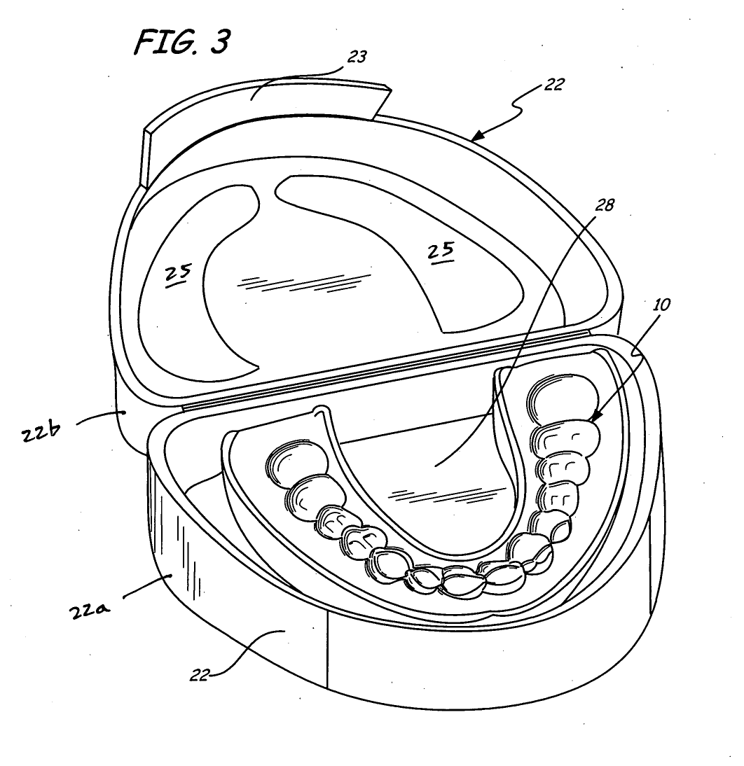

As shown in FIG. 3, case 22 should be sized, so that its interior volume 28 not only accommodates the mouth guard 10, but also secures it in place without allowing it to slide around to much and risk damage to the mouth guard when an impact force is inadvertently applied to the case.

For daily cleaning, the mouth guard 10 can have a portion of the antimicrobial cleaning composition poured onto it, preferably for less than one minute, followed by light brushing using brush 24 to enhance contact by the cleaning composition with microorganisms existing on the surfaces 14 of the mouth guard 10 and inside tooth imprint channels 16 therein. The mouth guard 10 is then rinsed with cool water and stored in case 22.

For weekly cleaning, the mouth guard is soaked in the cleaning composition which has been poured into the case 22 or other suitable container which can hold the mouth guard 10. The mouth guard 10 should be soaked in this cleaning composition for a time period of one minute to 24 hours, preferably 10 minutes to 12 hours, more preferably 15-30 minutes. Then, it should be removed from the container, lightly brushed with brush 24, rinsed with cool water, and stored in case 22. While brushing and cool water rinsing are not necessary to the antimicrobial cleaning process, they assist with the removal from the mouth guard 10 of heavy stains and plaque buildup.

For severely soiled mouth guards or night guards, they should be soaked in the cleaning composition for 2-24 hours to remove microorganisms and odors, more preferably 3-12 hours. They should then be removed from the composition, lightly brushed with brush 24, rinsed with cool water, and stored in case 22. For heavy staining, this process should be repeated.

In an alternate mini-wipes embodiment 40 shown in FIG. 4, the antibacterial dental appliance cleaning composition of this invention can be incorporated into a wet wipe or towelette 42, which is contained within an air-tight package 44 until use. Such wet wipe towelettes 42 may be made from paper, cloth, or other fiber products, and come in discrete sheets or tear away panels. Each sheet or panel should be impregnated with the antimicrobial cleaning composition solution, preferably to ensure full coverage by the solution throughout the sheet. The wet wipe towelette 42 should be robust enough to not disintegrate upon use; but may be designed to biodegrade over time after its use. A spun-lace, non-woven fabric made from, e.g., 100% cotton, 50% viscose, or 50% polyester is appropriate for purposes of this invention.

For purposes of this invention, the wet wipe towelette panel size should preferably be approximately 2.75 inches×4 inches (7.5 cm×10 cm). They are packaged in a moisture-impermeable container 46 made from thin, flexible material, such as plastic, vinyl, or foil. Unless only a single wet wipe towelette is contained in such a package 46 (i.e., a single-use wipe), the package should contain a peel-away flap 48 for dispensing one wet wipe towelette sheet at a time to the user with a re-seal capability for securing the flap 48 to the package to keep the unused towelettes moist. As a unique feature, the package 46 has a small Velcro® strip on its back to enable the user to attach the wet wipe towelette package 46 to a cooperating Velcro strip mounted to a side of the mouth guard case 22, so that wet wipe towelettes containing the antimicrobial cleaning composition of this invention are always conveniently available for cleaning the mouth guard. This arrangement of attaching the package of wet wipe towelettes to the case also provides a convenient reminder to the user of the need to clean the mouth guard 10. When the package is empty, the user may simply remove the empty package from the case and attach a new package of the wet wipe towelettes.

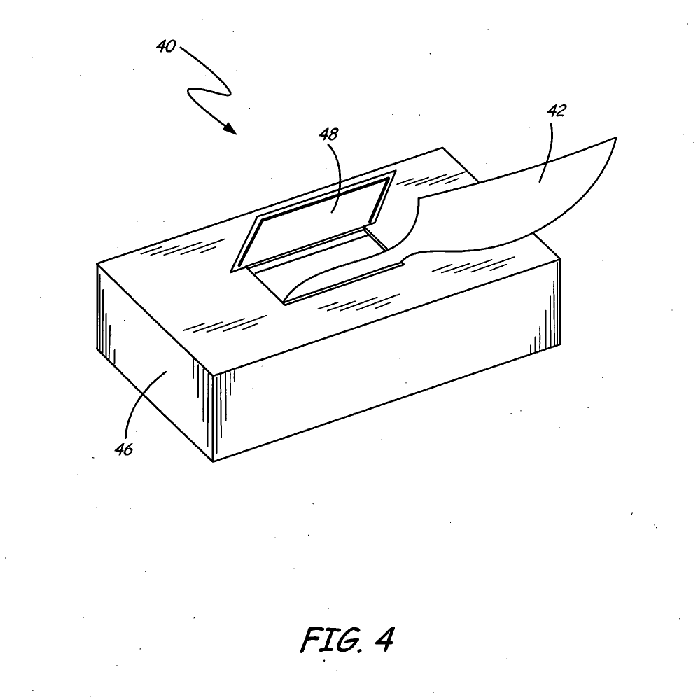

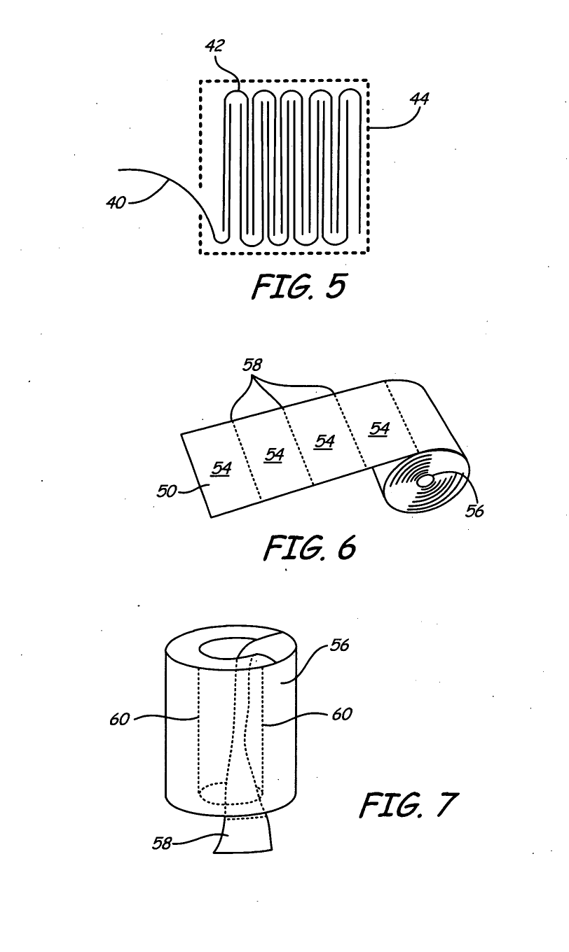

The wet wipe towelettes 42 rectangular or square panels are preferably folded in upon themselves in bipartite panels overlapping between individual towelettes in an “accordion” arrangement, as shown in FIG. 5. In this manner, pulling the leading edge 40 of a towelette 42 to take possession of it will cause the next towelette 42 to be pulled forward to the standby position. A block of, e.g., 15 sheets stacked in this accordion arrangement can be dropped into the package and sealed to maintain the moisture of the antimicrobial cleaning solution.

Instead of individual towelettes, the towelette may also constitute one long ribbon 50 on a roll with a multitude of serrated cuts 52 to form individual panels 54, as shown more clearly in FIG. 6. The towelette roll may be wound into a roll 56, so that pulling the first panel will not only allow it to be separated from the roll along the serration line, but also pull the next panel into the standby position. In still another embodiment, the towelette ribbon 50 can be internally wound so that the leading edge 58 is on the inside of the roll, instead of the outside, as shown more clearly in FIG. 7. Such an arrangement, with internal winding 60 of the ribbon roll, provides more resistance to the towelettes as they are pulled and separated from the roll, and contains the antimicrobial cleaning composition impregnated within the towelettes more completely in order to reduce evaporation.

Such package 46 of wet wipe towelettes 42 can be kept in a gym bag, athletic bag, purse or other portable container for quick and convenient cleanup of the mouth guard 10 or other dental appliance on the go. The wipe 42 is simply removed from its package 46 and used to wipe the inside and outside topical surfaces of the mouth guard 10, paying special attention to the u-shaped channel 14 and tooth indent channels 16, to remove any microorganisms that may be on or within it. The mouth guard 10 should ideally be wiped before and after each time it is worn, and if the mouth guard comes into contact with possible contaminated surfaces, such as turf or grass sports fields, locker room benches, or inside the lockers where athletic equipment is stored. This will provide a fresh-tasting, germ-free mouth guard that is then inserted into the user's mouth. It should be noted that the packaged wet wipe towelette embodiment for delivering the antimicrobial cleaning solution of this invention may be applied with equal application to other forms of dental appliances, such as orthodontic retainers and night guards which frequently come into contact with dirty counters and lunch tables.

The present invitation is illustrated by the following examples for the purpose of illustration and is not to be regarded as limiting the scope of the invention or manner in which it may be practiced.

### Example 1

### Preparation of the Cleaning Composition

An antimicrobial dental appliance cleaning rinse composition of the present invention was prepared as follows. The ingredients for the cleaning rinse composition are shown in Table 3:

TABLE 3

| Ingredient | Wt % | Grams |
|---|---|---|
| Deionized water | 90.890 | 2544.92 |
| Glycerin (99.9 wt % USP) | 5.000 | 140.00 |
| Glacial acetic acid | 0.500 | 14.00 |
| Grapefruit seed extract (GSE) | 1.000 | 28.00 |
| Sodium benzoate/potassium sorbate | 0.250 | 7.00 |
| PEG-40 hydrogenated castor oil | 2.216 | 62.05 |
| Natural peppermint oil | 0.044 | 1.23 |
| Blue #1 aqueous solution (0.1 wt %) | 0.100 | 2.80 |
| | 100.00 | 2800.00 |

2,544.92 grams of deionized water and 140.00 grams of glycerin sourced from IFFCO (Malyasia) Sdn. BHD were added together in a mixing tank. 14.00 grams of glacial acetic acid sourced from Spectrum Laboratory Products Inc. of Gardena, Calif. was added to the mixture in the tank and mixed therein by means of an impeller paddle. Next, 28.00 grams of NutriBiotic® grapefruit seed extract (GSE) was added to the tank and mixed therein. 7.00 grams of sodium benzoate/potassium sorbate admixture in the form of Geogard Ultra/PPOH-35 sourced from Thor Specialties, Inc. of Trumbull, Conn. was added to the tank as a stabilizer for the flavorant/deodorizer and colorant to be added to the tank. 62.05 grams of PEG-40 hydrogenated castor oil in the form of Cremophor® RH 40 sourced from BASF Corporation of Germany was added next to the tank as a solubilizer for the flavorant/deodorizer to be added to the tank. These ingredients were thoroughly mixed into the composition in the tank by means of the impeller paddle. Next, 1.23 grams of natural peppermint oil sourced in the form of Oil Peppermint Natural P0003 sourced from Ungerer & Company of Lincoln Park, N.J. was added to the tank as the flavorant/deodorizing agent. Finally, 2.80 grams of #1 Blue aqueous solution sourced in the form of FD&C Blue #1 from Science Lab.com, Inc. of Houston, Tex. was added to the tank as the colorant. The composition was thoroughly mixed together by means of the impeller paddle in the tank to yield the final 2,800.00 grams of antimicrobial dental appliance cleaning rinse composition.

### Example 2

### Detection of Representative Antimicrobial Activities

A lab technician swabbed the interior surface of her mouth with a cotton swab. The swab was put into Brain Heart Infusion (“BHI”) Broth, which is a non selective nutrient enrichment broth. This was grown overnight at 35° C. The enriched broth was diluted using sterile Butterfield's diluents, and plated using TSA/YE (Tryptic Soy Agar with Yeast Extract). The dilution was done to get countable isolated colonies.

Fourteen isolated colonies were selected to be gram stained. All colonies were gram positive cocci. Each of these fourteen colonies was used to inoculate a separate BHI broth tube that was incubated overnight at 35° C. Petri plates were labeled 1-14 to correspond with the fourteen BHI broth tubes inoculated with the isolated colonies. To each petri plate, 1 ml of the grown BHI broth inoculum was added to the corresponding labeled petri plate. Fifteen ml of the TSA/YE agar was added to each plate and swirled to mix the bacteria inoculum with the tempered TSA/YE agar.

The agar was left to solidify at room temperature for about 15 minutes.

Five separate wells were cut into the solidified agar using a 16 mm cork borer sterilized by dipping in alcohol and flaming. To each of the five wells 50 μl of the antimicrobial cleaning rinse compound was added to each corresponding well in each of the fourteen seeded petri plates. The diluted antimicrobial cleaning rinse compound was prepared by using sterile Butterfield's Diluent to make a 15%, 25%, 50%, and 100% solution of the antimicrobial cleaning rinse compound. The plates were incubated overnight at 35° C.

A zone of inhibition (clearing indicating no bacteria was able to grow next to the wells due to the leaching of the test material into the agar around the well) was seen around each of the wells corresponding to the different percent solutions of the antimicrobial cleaning rinse composition product, so it was determined that the product successfully killed bacteria. No attempt was made to isolate the bacterial colonies for type.

### Example 3

### Detection of Antimicrobial Activities for Known Bacteria Types

The method of Example 2 was repeated except that the seven petri plates were incubated with the following seven bacterial types in agar: Staphylococcus aureus, E. coli, Enterococcus facium, Pseudomonas aeroginosa, Shigella, Listeria monocytogenes, and Salmonella. An eighth petri plate was incubated with the enriched bacteria growth from the swab of the technician's mouth. 50 μl solutions of the 5%, 15%, 25%, 50%, and 100% concentrations of the antimicrobial cleaning rinse composition of Example 1 were prepared and used to inoculate wells made in the TSA/YE agar, as described in Example 2. Following overnight incubation of the petri plates at 35° C., it was determined that the cleaning rinse composition product produced zones of inhibition at all concentrations for the Staphylococcus aureus, Enterococcus facium, and Listeria monocytogenes bacteria. The Salmonella and swabbed mouth bacteria only showed zones of inhibition by the cleaning rinse composition product at 100% concentration. No zones of inhibition were detected for the product for the E. coli, Pseudomonas aeroginosa, and Shigella bacteria, these bacteria should not be found in healthy individuals, although these types of bacteria are not known for existing inside the mouth of humans.

### Example 4

### Bacteria Count Resulting from Treatment of Mouth Swab

A lab technician swabbed the interior surface of her mouth with a cotton swab. The swab was put into BHI Broth, which is a non selective nutrient enrichment broth. This was grown overnight at 35° C. The enriched broth was diluted using sterile Butterfield's diluent and plated using TSA/YE (Tryptic Soy Agar with Yeast Extract). The dilution was done to get countable isolated colonies.

Ten-fold dilutions were performed by adding 1 μl of the BHI enriched broth to 10 μl of sterile Butterfield's diluent. For example; 1 μl of the enriched broth culture was added to 9.0 μl of the buffer dilution to yield a 1:10 dilution. This sample was mixed using a vortex mixer for 30 seconds. Next, 1 μl from the 1:10 dilution was added to 9.0 μl of the diluents to produce a 1:100 dilution. This sequential dilution scheme was followed to end up with a 1:1,000,000 dilution. A total aerobic plate count of the bacteria sample swabbed from the mouth was calculated by counting the bacteria on each of the dilution plates with the aid of a backlit magnifier by adding them and adjusting for the dilution factor to produce an aggregate count value. This last sample had a count of 13 colonies on the 1:1,000,000 dilution to indicate 13,000,000 CFU/ml.

Another swab was taken of the technician's mouth. This swab was placed into a solution of 50% BHI broth and 50% of the antimicrobial cleaning rinse composition solution of Example 1. After incubation overnight at 35° C., dilutions were performed from this solution in accordance with the method described above to determine the aggregate bacteria load in the enrichment. This aggregate bacteria cell count for the treated sample was <1 CFU/ml, showing that the antimicrobial cleaning rinse product worked very well to eradicate the bacteria.

### Example 5

### Bacteria Count for Treated Dental Appliances

A variety of mouth guards, night guards, and orthodontic retainers were used by youth athletes and students. Each such dental appliance was swabbed after being removed from the mouth to produce a representative bacteria sample. In some cases, the dental appliance was then rinsed with water. Each of the dental appliances was then soaked in a full strength solution of the antimicrobial cleaning rinse composition product prepared in accordance with Example 1 for a time period between 15 minutes and 12 hours determined by the user of the dental appliance to accommodate his or her real-life schedule. These dental appliances, their treatment soak times, and any pre-water rinses applied thereto are identified in Table 4 shown below. The dental appliances were then removed from their respective antimicrobial cleaning rinse composition solutions and the cleaning solutions were saved.

TABLE 4

| | Dental Appliance | Treatment Soak | |
|---|---|---|---|
| Test ID# | Tested | Time (Hours) | Water Pre-Rinse |
| 1 | Night Guard | 2.0 | No |
| 2 | Night Guard | 0.25 | No |
| 3 | Night Guard | 1.0 | No |
| 4 | Night Guard | 2.0 | Yes |
| 5 | Retainer | 12.0 | Yes |
| 6 | Night Guard | 0.33 | Yes |
| 7 | Retainer | 0.33 | Yes |
| 8 | Retainer | 1.0 | Yes |
| 9 | Mouth Guard | 1.0 | Yes |
| 10 | Retainer | 12.0 | No |
| 11 | Retainer | 0.33 | Yes |
| 12 | Retainer | 2.0 | Yes |
| 13 | Mouth Guard | 12.0 | No |
| 14 | Mouth Guard | 2.0 | No |
| 15 | Retainer | 2.0 | No |
| 16 | Retainer | 2.0 | No |
| 17 | Mouth Guard | 1.0 | No |
| 18 | Night Guard | 1.0 | No |
| 19 | Retainer | 1.0 | No |
| 20 | Mouth Guard | 6.0 | No |
| 21 | Mouth Guard | 0.25 | Yes |
| 22 | Not tested | | |
| 23 | Mouth Guard | 12.0 | No |
| 24 | Mouth Guard | 0.25 | No |
| 25 | Mouth Guard | 1.0 | Yes |

Next, each of the microbial-laden swabs obtained from the 24 dental appliances before their treatment with the antimicrobial cleaning rinse composition were immersed in a quantity of BHI broth to inoculate it with the microorganisms found on the swab. This BHI broth inoculated with the swab was incubated overnight. Each of the solutions was then plated in agar and incubated overnight at 35° C. to produce a set of pre-treatment microorganism cultures for the dental appliances.

The set of cleaning solutions used to treat the dental appliances were then plated in agar and incubated overnight at 35° C. to produce a set of post-treatment microorganism cultures for the dental appliances. Dilutions were performed following this dilution scheme. 1 μl sample taken from the Sample 1 pre-treatment microorganism culture was plated directly. Reporting sensitivity=<1 CFU/ml. 1 μl of the concentrated solution was added to 9 μl of the Butterfield's buffer solution diluent to produce a 1:10 dilution. 1 μl of the 1:10 dilution solution was then added to 9 μl of diluent to produce a 1:100 dilution. Ten-fold dilutions were sequentially performed using the scheme described above to produce 1:1000, 1:10,000, 1:100,000, and 1:1,000,000 dilution plates.

An aerobic plate count of the bacteria sample swabbed from the Sample 1 mouth guard was calculated by counting the bacteria on each of the dilution plates with the aid of a backlit magnifier by adding them and adjusting for the dilution factor to produce an aggregate count value. For example, if 13 bacteria were counted on the 1/1000 dilution plate, this would yield a count of 13,000 bacteria. The aggregate bacteria count for the swabbed sample was 13,000,000 CFU/ml. This process for creating the dilution plates and calculating the aggregate microorganism count values was repeated for each of the other 24 pre-treatment microorganism cultures.

Next, 1:10, 1:100, 1:1000, 1:10,000, 1:100,000, and 1:1,000,000 dilution plates were prepared from the plated post-treatment microorganism culture for the Sample 1 mouth guard, and an aggregate bacterial count was calculated for this sample. This process was repeated for each of the other 24 post-treatment microorganism cultures.

The pre-treatment and post-treatment aggregate microorganism counts for each of the 24 dental appliance samples is reported in Table 5 in which the entries have been reordered to group the results for each type of dental appliance together.

TABLE 5

| | | Micro- | Micro- | | | |
|---|---|---|---|---|---|---|
| | | organisms | organisms | | | |
| | | Count | Count | Soak | Added | % Micro- |
| | | Before | After | Time | Water | organism |
| Test ID# | Item Tested | Treatment | Treatment | (hours) | Rinse? | Reduction |
| 9 | Mouth Guard | 90,000 | <1 | 1 | Yes | 99.9 |
| 25 | Mouth Guard | 640,000 | 50 | 1 | Yes | 99.9 |
| 23 | Mouth Guard | 6,000 | 42 | 12 | No | 99.3 |
| 24 | Mouth Guard | 83,000 | 240 | 0.25 | No | 99.7 |
| 20 | Mouth Guard | 230,000 | 9 | 6 | No | 99.9 |
| 13 | Mouth Guard | 560,000 | 1500 | 12 | No | 99.7 |
| 2 | Mouth Guard | 580,000 | 1 | 0.25 | No | 99.9 |
| 17 | Mouth Guard | 590,000 | 7 | 1 | No | 99.9 |
| 21 | Mouth Guard | 700,000 | 10 | 0.25 | Yes | 99.9 |
| 14 | Mouth Guard | 38,000,000 | 3100 | 2 | No | 99.9 |
| 4 | Night Guard | 340,000 | 860 | 2 | Yes | 99.7 |
| 18 | Night Guard | 410,000 | 31 | 1 | No | 99.9 |
| 3 | Night Guard | 1,200,000 | <1 | 1 | No | 99.9 |
| 1 | Night Guard | 8,600,000 | 87 | 2 | No | 99.9 |
| 6 | Night Guard | 51,000,000 | 5,700 | 0.33 | Yes | 99.9 |
| 12 | Retainer | 40,000 | 300 | 2 | Yes | 99.3 |
| 11 | Retainer | 85,000 | 42 | 0.33 | Yes | 99.9 |
| 15 | Retainer | 500,000 | 36 | 2 | No | 99.9 |
| 10 | Retainer | 660,000 | <1 | 12 | No | 99.9 |
| 19 | Retainer | 720,000 | 230 | 1 | No | 99.9 |
| 16 | Retainer | 1,700,000 | 7 | 2 | No | 99.9 |
| 7 | Retainer | 2,400,000 | 2800 | 0.33 | Yes | 99.9 |
| 5 | Retainer | 4,600,000 | 220 | 12 | Yes | 99.9 |
| 8 | Retainer | 5,700,000 | 600 | 1 | Yes | 99.9 |

These results show that the anti-microbial dental appliance rinse composition of the present invention was highly effective in eliminating on a consistent basis 99.3-99.9% of the microorganisms found on the dental appliances over a wide range of soak times. Even a short soak time like 15 minutes yielded 99.9% antibacterial reduction results. Moreover, these incredible results were achieved with GSE as the only primary antimicrobial agent. Prior art products typically include multiple anti-bacterial agents in order to yield acceptable results. Furthermore, the very high microorganism reductions rather were achieved not only on hard surfaced dental appliances like retainers, but also for soft flexible dental appliances like mouth guards and night guards where difficult to reach microorganism can reside.

Compared with the results reported by Dr. Harich in his U.S. Pat. No. 5,631,001 for a GSE-based disinfectant, the dental appliance cleaner product of the present invention performs its anti-microbial properties admirably. Based upon the NutriBiotic GSE liquid concentrate constituting ⅓ grapefruit seed extract and ⅔ glycerin, then the dilution value of the GSE component of the formulation of the present invention is approximately 1:300. Nearly 100% of the microorganisms on the mouth guards, night guards, and retainers were killed by this GSE formulation product within 0.25-1.0 hours of immersion contact time. By contrast, Harich required 1-2 hours of contact time for his GSE disinfectant at a substantially more concentrated 1:100 dilution and 24 hours or more at a less concentrated 1:1000 dilution. Thus, the GSE product formulation of the present invention performed an equivalent microorganism kill rate at substantially lower GSE concentrations requiring significantly less treatment time. While not wanting to be limited by any particular theory, it is believed that the glacial acetic acid component of the product formulation of the present invention may assist the anti-microbial performance of the GSE component by removing the scale buildups (e.g., plaque, food particles) from the dental appliance. Moreover, it is possible that the GSE and glacial acetic acid components may produce a synergistic effect in killing or reducing the incidence of the microorganisms on the dental appliance. As an added benefit, the GSE product formulation of the present invention removes foul odors from the dental appliance. Harich's GSE disinfectant product does not address odor control.

Longer soak times or repeated soakings using the antimicrobial cleaning rinse of the present invention have been found to improve odor reduction and break down buildups on heavily stained and soiled dental appliances.

### Example 6

### Comparative Products Test Methodology & Results

Comparative tests of the antimicrobial performance of the cleaning composition of the present invention against a number of prior art cleaning products available in the marketplace were performed in accordance with the methodology set forth within Example 5. The prior art products tested were warm rinse water, Polident® antibacterial denture cleaner, Palmolive® dish soap with warm water, Scope® Mouthwash, Efferdent® antibacterial denture cleaner, Glean Guard® ultraviolet light sanitizer, and Crest® toothpaste with a toothbrush. Mouth guards were swabbed to produce a pre-test bacterial count, and then treated with the given antibacterial treatment to produce a post-test bacterial count. The results from this comparative test regimen are reported in Table 6.

TABLE 6

| | | Micro- | | Micro- | |
|---|---|---|---|---|---|
| | | organisms | | organisms | |
| | | Count | Time | Count | % Micro- |
| Sample | | Before | Cleaned | After | organisms |
| No. | Product Tested | Treatment | (minutes) | Treatment | Reduction |
| 1 | Warm water rinse | 1,000,000 | 0.75-1.0 | 1,200,000 | −20.0 |
| 1 Rerun | Warm water rinse | 800,000 | 0.75-1.0 | 700,000 | 12.5 |
| 2 | Polident antibacterial denture | 1,200,000 | 3 | 100,000 | 92.6 |
| | cleaner | | | | |
| 3 | Palmolive dish soap with | 76,000 | ca. 1.5 | 770 | 98.9 |
| | water | | | | |
| 4 | Scope mouthwash | 900,000 | 15 | 310 | 99.9 |
| 5 | Efferdent antibacterial denture | 80,000,000 | 15 | 3,600,000 | 95.5 |
| | cleaner | | | | |
| 6 | GleanGuard ultraviolet light | 77,000 | 10 | 1,200 | 98.4 |
| | sanitizer | | | | |
| 7 | Antimicrobial cleaning | 1,800,000 | 15 | 600 | 99.9 |
| | composition of this invention | | | | |
| 8 | Crest toothpaste and brush | 8,600,000 | ca. 1.5 | 100,000 | 98.8 |

As can be seen from these results a warm water rinse does not provide a very effect microorganism reduction treatment. The other antimicrobial treatment products and methods do provide antimicrobial properties in excess of 90% microorganism reduction, although the antimicrobial cleaning composition of the present invention produces the best results (99.9% microorganism reduction). Moreover, the antimicrobial cleaning composition of the present invention does not contain the potential harmful persulfate, monopersulfate, and ethylenediaminetraacetic acid ingredients of Efferdent and Polident denture cleaners; and does not break down plastic materials in mouth guards like ultraviolet light-based cleaners. Furthermore, unlike the antimicrobial cleaning composition of the present invention, the Polident and Efferdent denture cleaners, Scope mouthwash, Crest toothpaste, Palmolive dish soap, GleanGuard ultraviolet light sanitizer, and warm water rinse did nothing to treat the stains and foul odors on the mouth guards. Thus, the antimicrobial cleaning composition of the present invention is clearly superior over the prior art products and methods for cleaning and removing microorganisms, stains, and foul odors from dental appliances like mouth guards.

The above specifications and drawings provide a complete description of the formulation for the antimicrobial dental appliance cleaning composition of the present invention, and its application as a rinse or towlette wipe to the dental appliance. However, the invention is capable of use in various other combinations, modifications, embodiments, and environments without departing from the spirit and scope of the invention. Therefore, the description is not intended to limit the invention to the particular form disclosed, and the invention resides in the claim and hereinafter appended.

What is claimed is:

1. An antimicrobial rinse composition used for cleaning a dental appliance immersed therein, such composition comprising:
(a) an effective amount of at least one plant-based antimicrobial extract compound; and
(b) a cleaning agent selected from the group consisting of an alpha-hydroxy acid, hydrogen peroxide, denatured alcohol, ethanol, or mixtures thereof;
(c) wherein the plant-based antimicrobial extract compound and the cleaning agent work in combination to reduce or eradicate microorganisms and stains or odors from the surface of the dental appliance without the inclusion of any antimicrobially effective amounts of ascorbic acid or metal cations, or any allergy-inducing agents, anti-calculus agents, anti-plaque agents, fluoride ion source, desensitizing agents, H₂ antagonits, or chemically-derived malodor control agents.

2. The antimicrobial rinse composition of claim 1, wherein the plant-based antimicrobial extract compound is derived from the seed or pulp of a Citrus family plant.

3. The antimicrobial rinse composition of claim 2, wherein the plant-based antimicrobial extract compound is grapefruit seed extract (“GSE”).

4. The antimicrobial rinse composition of claim 1, wherein the plant-based antimicrobial extract compound is derived from the seed or pulp of a Vitis family plant.

5. The antimicrobial rinse composition of claim 1, wherein the alpha-hydroxy acid is acetic acid.

6. The antimicrobial rinse composition of claim 1, wherein the alpha-hydroxy acid is lactic acid.

7. The antimicrobial rinse composition of claim 1, wherein the alpha-hydroxy acid is glycolic acid.

8. The antimicrobial rinse composition of claim 1, wherein the alpha-hydroxy acid is citric acid.

9. The antimicrobial rinse composition of claim 1, wherein the dental appliance is a mouth guard.

10. The antimicrobial rinse composition of claim 1, wherein the dental appliance is a night guard.

11. The antimicrobial rinse composition of claim 1, wherein the dental appliance is a orthodontic retainer.

12. The antimicrobial rinse composition of claim 1, wherein the dental appliance is orthodontic braces.

13. The antimicrobial rinse composition of claim 1 further comprising a carrier material.

14. The antimicrobial rinse composition of claim 1, wherein the carrier material is water.

15. The antimicrobial rinse composition of claim 1 further comprising at least one additive selected from the group consisting of a stabilizer, solubilizer, flavorant, colorant, or natural deodorizer.

16. An antimicrobial towelette used for cleaning a dental appliance, comprising:
(a) a towelette;
(b) an antimicrobial cleaning composition incorporated into the towelette comprising:
(i) an effective amount of at least one plant-based antimicrobial extract compound; and
(ii) a cleaning agent selected from the group consisting of an alpha-hydroxy acid, hydrogen peroxide, denatured alcohol, ethanol, or mixtures thereof;
(c) wherein wiping the dental appliance with the towelette, the plant-based antimicrobial extract compound and the cleaning agent work in combination to reduce or eradicate microorganisms and stains or odors from the surface of the dental appliance without the inclusion of any antimicrobially effective amounts of ascorbic acid or metal cations, or any allergy-inducing agents, anti-calculus agents, anti-plaque agents, fluoride ion source, desensitizing agents, H₂ antagonits, or chemically-derived malodor control agents.
